(19) United States
(12) Patent Application Publication
(10) Pub. No.: US 2026/0330809 A1
(43) Pub. Date: Oct. 22, 2026

(54) LEARNING SYSTEM, DETECTION SYSTEM, LEARNING METHOD, AND NON-TRANSITORY COMPUTER-READABLE MEDIUM

(71) Applicant: NEC Corporation, Tokyo (JP)

(72) Inventor: Yuya MATSUMOTO, Tokyo (JP)

(73) Assignee: NEC Corporation, Tokyo (JP)

(21) Appl. No.: 19/642,765

(22) Filed: Apr. 9, 2026

(30) Foreign Application Priority Data
Apr. 21, 2025 (JP) 2025-069390

(51) Int. Cl. G06V 10/77; G06V 10/25; G06V 10/774; G06V 10/776; G06V 10/82

(52) U.S. Cl. CPC G06V 10/7715; G06V 10/25; G06V 10/774; G06V 10/776; G06V 10/82; G06V 2201/07

(57) ABSTRACT

A learning system according to the present disclosure includes at least one processor configured to execute the instructions to generate a feature map indicating a feature value for each pixel on a bird's-eye-view plane based on one or more pieces of sensor data, generate a heat map indicating a certainty factor of the presence of a plurality of detection targets for each pixel on the bird's-eye-view plane based on the feature map, sample, based on ground truth data including a ground truth region for each of the detection targets on the bird's-eye-view plane, the feature map, and the heat map, for each of the ground truth regions, the feature value corresponding to a pixel having the highest certainty factor among pixels at least partially included in the ground truth region, detect regions of the detection targets on the bird's-eye-view plane based on the feature values sampled by the sampling.

### INCORPORATION BY REFERENCE

This application is based upon and claims the benefit of priority from Japanese patent application No. 2025-069390, filed on Apr. 21, 2025, the disclosure of which is incorporated herein in its entirety by reference.

### TECHNICAL FIELD

The present disclosure relates to a learning system, a detection system, a learning method, and a learning program.

### BACKGROUND ART

JP 2023-027736 A discloses a technique of detecting an object by using, for example, sensing data such as image data and point cloud data as input and generating a feature map of a bird's eye view (BEV) that two-dimensionally represents a distribution of feature values extracted from the sensing data.

### SUMMARY

The inventors have found the following problems regarding models that generate a feature map of a bird's eye view to detect objects.

During training of a model, the model detects a heat map indicating the presence certainty factor for a detection target in each pixel on a bird's-eye-view plane based on the feature map of a bird's eye view. Then, the model selects a plurality of pixels having the highest certainty factor values in the heat map, and samples feature values corresponding to these pixels from the feature map. The model detects a region of the detection target on the bird's-eye-view plane using the sampled feature values.

However, in such sampling based on the heat map, the pixels corresponding to all the detection targets are not always selected as pixels with the highest certainty factors. For a detection target that tends to have a relatively low certainty factor, such as a small vehicle or a partially occluded pedestrian, a sufficiently high certainty factor may not be obtained on the heat map and that detection target may not be sampled. As a result, there is a problem that learning regarding the detection target is not sufficiently performed, and sufficient detection accuracy cannot be obtained for some objects.

The present disclosure has been made to solve such a problem, and an example object thereof is to provide a learning system, a detection system, a learning method, and a learning program capable of improving detection accuracy.

A learning system according to an example aspect of the present disclosure includes at least one memory storing instructions, and at least one processor configured to execute the instructions to generate a feature map indicating a feature value for each pixel on a bird's-eye-view plane based on one or more pieces of sensor data, generate a heat map indicating a certainty factor of the presence of a plurality of detection targets for each pixel on the bird's-eye-view plane based on the feature map, execute, based on ground truth data including a ground truth region for each of the detection targets on the bird's-eye-view plane, the feature map, and the heat map, first sampling to sample, for each of the ground truth regions, the feature value corresponding to a pixel having the highest certainty factor among pixels at least partially included in the ground truth region, detect regions of the detection targets on the bird's-eye-view plane based on the feature values sampled by the sampling, calculate a loss between the detected regions and the ground truth regions, and update a model based on the loss.

A detection system according to an example aspect of the present disclosure includes, by at least one processor, the learning method comprising:
a feature map generation step of generating a feature map indicating a feature value for each pixel on a bird's-eye-view plane based on one or more pieces of sensor data, a heat map generation step of generating a heat map indicating a certainty factor of the presence of a plurality of detection targets for each pixel on the bird's-eye-view plane based on the feature map, a sampling step of sampling, based on ground truth data including a ground truth region for each of the detection targets on the bird's-eye-view plane, the feature map, and the heat map, for each of the ground truth regions, the feature value corresponding to a pixel having the highest certainty factor among pixels at least partially included in the ground truth region, a detection step of detecting regions of the detection targets on the bird's-eye-view plane based on the sampled feature values, a loss calculation step of calculating a loss between the detected regions and the ground truth regions, and an update step of updating a model based on the loss.

A learning method according to an example aspect of the present disclosure includes a feature map generation step of generating a feature map indicating a feature value for each pixel on a bird's-eye-view plane based on one or more pieces of sensor data, a heat map generation step of generating a heat map indicating a certainty factor of the presence of a plurality of detection targets for each pixel on the bird's-eye-view plane based on the feature map, a sampling step of sampling, based on ground truth data including a ground truth region for each of the detection targets on the bird's-eye-view plane, the feature map, and the heat map, for each of the ground truth regions, the feature value corresponding to a pixel having the highest certainty factor among pixels at least partially included in the ground truth region, a detection step of detecting regions of the detection targets on the bird's-eye-view plane based on the sampled feature values, a loss calculation step of calculating a loss between the detected regions and the ground truth regions, and an update step of updating a model based on the loss.

A non-transitory computer-readable medium storing a learning program according to an example aspect of the present disclosure causes a computer to execute feature map generation processing of generating a feature map indicating a feature value for each pixel on a bird's-eye-view plane based on one or more pieces of sensor data, heat map generation processing of generating a heat map indicating a certainty factor of the presence of a plurality of detection targets for each pixel on the bird's-eye-view plane based on the feature map, sampling processing of sampling, based on ground truth data including a ground truth region for each of the detection targets on the bird's-eye-view plane, the feature map, and the heat map, for each of the ground truth regions, the feature value corresponding to a pixel having the highest certainty factor among pixels at least partially included in the ground truth region, detection processing of detecting regions of the detection targets on the bird's-eye-view plane based on the sampled feature values, loss calculation processing of calculating a loss between the detected regions and the ground truth regions, and update processing of updating a model based on the loss.

According to the present disclosure, it is possible to provide a learning system, a detection system, a learning method, and a learning program capable of improving detection accuracy.

### BRIEF DESCRIPTION OF THE DRAWINGS

FIG. 1 is a block diagram illustrating an example of a configuration of a learning system according to the present disclosure;

FIG. 2 is a block diagram illustrating example configurations of a learning system and a detection system according to the present disclosure;

FIG. 3 is a block diagram illustrating an example of a configuration of a learning unit according to the present disclosure;

FIG. 4 is a diagram illustrating an example of a heat map according to the present disclosure;

FIG. 5 is a diagram illustrating another example of a heat map according to the present disclosure;

FIG. 6 is a flowchart illustrating an example of a learning method according to the present disclosure;

FIG. 7 is a flowchart illustrating an example of a sampling method according to the present disclosure; and

FIG. 8 is a block diagram illustrating an example of a hardware configuration that implements the processing of the learning system according to the present disclosure.

### EXAMPLE EMBODIMENT

### First Example Embodiment

### Configuration of Learning System

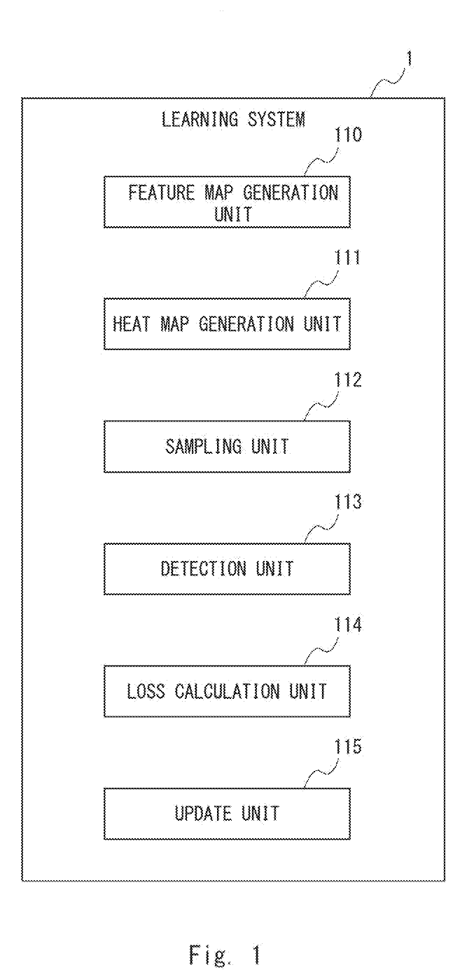

Hereinafter, an example of a learning system will be described with reference to FIG. 1. FIG. 1 is a block diagram illustrating an example of a configuration of a learning system according to the present disclosure. The learning system 1 is a system for machine learning of a model (not illustrated). As illustrated in FIG. 1, the learning system 1 includes a feature map generation unit 110, a heat map generation unit 111, a sampling unit 112, a detection unit 113, a loss calculation unit 114, and an update unit 115.

The feature map generation unit 110 generates a feature map indicating a feature value for each pixel on a bird's-eye-view plane based on one or more pieces of sensor data. More specifically, the feature map generation unit 110 extracts spatial feature values from an image, a point cloud, or the like based on the sensor data. Then, the feature map generation unit 110 rearranges the feature values on a bird's-eye-view plane through coordinate transformation, projection processing, or the like, thereby generating a two-dimensional feature map. The feature map is represented by, for example, a three-dimensional tensor of [D, H, W]. The symbol D indicates the number of dimensions of the feature vector corresponding to each pixel, and the feature vector includes, for example, image features, point cloud features, position information, and the like. The symbols H and W are the numbers of divisions in the height direction and the width direction of the bird's-eye-view plane. Examples of the sensor data include image data and point cloud data.

The heat map generation unit 111 generates a heat map indicating, for each pixel on the bird's-eye-view plane, the certainty factor of the presence of a plurality of detection targets based on the feature map. More specifically, the heat map generation unit 111 performs channel compression by performing predetermined neural network processing on the feature map. This channel compression converts the original D channels to n channels corresponding to the number of classes of the detection targets. The heat map thus obtained is formed by a three-dimensional tensor having an output shape of [n, H, W], with each pixel holding a certainty factor.

The sampling unit 112 samples feature values based on ground truth data including the ground truth region for each of the detection targets on the bird's-eye-view plane, the feature map, and the heat map. The sampled feature values are used for object detection by the detection unit 113 described later.

In the first example embodiment, the sampling unit 112 executes, for each ground truth region, first sampling to sample a feature value corresponding to the pixel having the highest certainty factor among pixels at least partially included in the ground truth region. The sampling unit 112 first selects, for each ground truth region included in the ground truth data, a pixel having the highest certainty factor in the heat map from among pixels at least partially included in the ground truth region. Then, the sampling unit 112 samples the feature values at the pixel positions on the feature map corresponding to the selected pixels. By the first sampling, the sampling unit 112 samples the feature value corresponding to the pixel having the highest certainty factor for every ground truth region included in the ground truth data.

By the first sampling, the learning system 1 can sample at least one feature value for every ground truth region, that is, every positive. Therefore, the learning system 1 can learn for all the detection targets from the initial stage of learning. Therefore, the detection accuracy of the model is improved.

The detection unit 113 detects each of a plurality of regions of detection targets on the bird's-eye-view plane based on the feature values sampled by the sampling unit 112.

The loss calculation unit 114 calculates the loss between the regions detected by the detection unit 113 and the ground truth regions.

The update unit 115 updates the parameters of the model based on the loss calculated by the loss calculation unit 114.

As described above, the learning system 1 trains the model by using the ground truth data including a ground truth region for each of the detection targets on the bird's-eye-view plane, and the input data of one or more pieces of sensor data. In the model training, the learning system 1 first generates a feature map of a bird's eye view based on the input data. In addition, the learning system 1 generates a heat map indicating, for each pixel on the bird's-eye-view plane, the presence certainty factor for a detection target based on the feature map. Then, the learning system 1 samples feature values based on the ground truth data, the feature map, and the heat map. The sampled feature values are used as inputs to prediction processing executed for loss calculation.

In the sampling of feature values, the learning system 1 identifies, for each ground truth region included in the ground truth data, the pixel having the highest certainty factor on the heat map among pixels at least partially included in the ground truth region, and samples the feature value corresponding to the pixel (first sampling). The first sampling enables sampling at least one feature value for every ground truth region, that is, every positive. Therefore, the learning system 1 can learn for all the detection targets from the initial stage of learning. Therefore, the detection accuracy of the model is improved. Furthermore, in the first sampling, the sampling unit 112 does not simply sample the feature value corresponding to the center position of a ground truth region, but selects and samples the feature value corresponding to the position having the highest certainty factor in the heat map. As a result, a model trained by the learning system 1 can easily learn a clearer peak at the center position of the detection target, and overlapping sampling is suppressed. Therefore, the detection accuracy of the model is improved.

### Second Example Embodiment

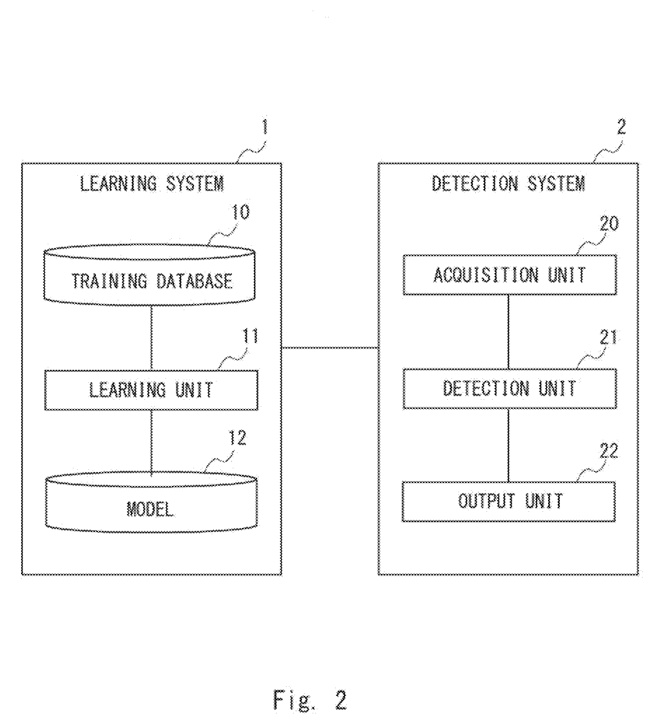

Examples of a learning system and a detection system will be described with reference to FIG. 2. FIG. 2 is a block diagram illustrating example configurations of a learning system and a detection system according to the present disclosure. The learning system 1 and the detection system 2 may be provided in the same device, or may be configured as separate devices that can communicate via a network or the like.

### Configuration of Learning System

The learning system 1 is a system for machine learning of a model 12. As illustrated in FIG. 2, the learning system 1 includes a training database 10, a learning unit 11, and the model 12.

The training database 10 stores ground truth data and input data corresponding to the ground truth data. The ground truth data and the input data are used to train the model 12 by the learning unit 11. Note that the training database 10 may be provided in a device or system different from the learning system 1.

The ground truth data includes a region of ground truth (hereinafter, ground truth region) for each detection target on a bird's-eye-view (BEV) plane and a certainty factor for ground truth (hereinafter, the ground truth certainty factor) for the ground truth region. Note that a “region” is not limited to a rectangular region such as the so-called bounding box, and includes, for example, a pixel set matching the outer shape of an object such as a segmentation mask, and information indicating a spatial position of a detection target, such as a contour line. In the second example embodiment, the region is a bounding box. The certainty factor indicates the probability of each detection target being present in each pixel on the bird's-eye-view plane.

Note that the ground truth data may further include the ground truth class label of the detection target. The class label is information for identifying the type of the detection target, such as a person, a car, or a traffic light.

The input data is one or more pieces of sensor data such as image data or point cloud data acquired by a sensor, a camera, or the like.

The model 12 is a model that has been trained through machine learning by the learning unit 11. The model 12 receives one or more pieces of sensor data such as image data and point cloud data, and detects one or more detection target regions on a bird's-eye-view plane. The model 12 generates a feature map based on the input sensor data, and further estimates a heat map based on the feature map. Then, the model 12 outputs detection target regions and certainty factors by using feature values corresponding to the positions having high certainty factors in the heat map. Note that the model 12 may further output class labels. In the second example embodiment, the model 12 is stored in the learning system 1. However, it may be stored in the detection system 2 or in an external storage or a cloud server different from the learning system 1 and the detection system 2.

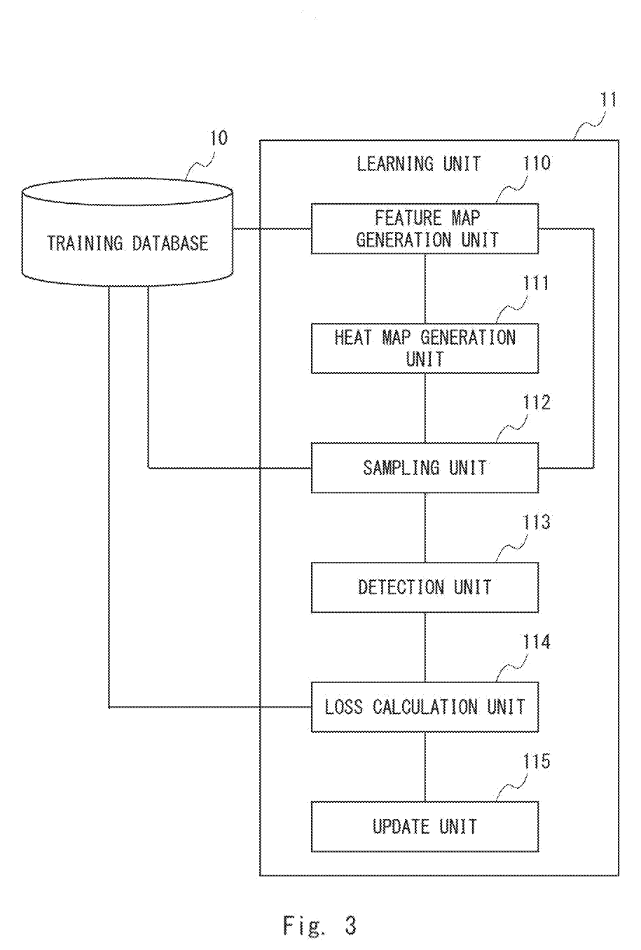

The learning unit 11 learns the model 12 using the ground truth data and the input data of the training database 10. FIG. 3 is a block diagram illustrating an example of a configuration of a learning unit according to the present disclosure. As illustrated in FIG. 3, the learning unit 11 includes a feature map generation unit 110, a heat map generation unit 111, a sampling unit 112, a detection unit 113, a loss calculation unit 114, and an update unit 115.

The feature map generation unit 110 acquires one or more pieces of sensor data from the training database 10. The feature map generation unit 110 generates a feature map indicating a feature value for each pixel on a bird's-eye-view plane based on one or more pieces of sensor data.

More specifically, the feature map generation unit 110 extracts spatial feature values from an image, a point cloud, or the like based on the acquired sensor data. Then, the feature map generation unit 110 rearranges the feature values on a bird's-eye-view plane through coordinate transformation, projection processing, or the like, thereby generating a two-dimensional feature map. The feature map is represented by, for example, a three-dimensional tensor of [D, H, W]. The symbol D indicates the number of dimensions of the feature vector corresponding to each pixel, and the feature vector includes, for example, image features, point cloud features, position information, and the like. The symbols H and W are the numbers of divisions in the height direction and the width direction of the bird's-eye-view plane.

The heat map generation unit 111 acquires the feature map generated by the feature map generation unit 110 from the feature map generation unit 110. The heat map generation unit 111 generates a heat map indicating, for each pixel on the bird's-eye-view plane, the certainty factor of the presence of a plurality of detection targets based on the acquired feature map.

More specifically, the heat map generation unit 111 performs channel compression by performing predetermined neural network processing on the feature map. This channel compression converts the original D channels to n channels corresponding to the number of classes of the detection targets. The heat map thus obtained is formed by a three-dimensional tensor having an output shape of [n, H, W], with each pixel holding a certainty factor.

The sampling unit 112 acquires ground truth data from the training database 10, acquires the feature map from the feature map generation unit 110, and acquires the heat map from the heat map generation unit 111. The sampling unit 112 samples feature values based on the acquired ground truth data, feature map, and heat map. The sampled feature values are used for object detection by the detection unit 113 described later. In the second example embodiment, the sampling unit 112 performs first sampling and second sampling. In the following, the first sampling and the second sampling will be described. In the following description, let the total number of feature values acquired by the first sampling and the second sampling be k (k is an integer of 2 or more), and the number of feature values acquired only by the first sampling be n (n is an integer of 1 or more and less than k). That is, the number of feature values acquired by the second sampling alone is (k - n).

The first sampling is processing of extracting a feature value corresponding to the pixel having the highest certainty factor among pixels in a ground truth region included in the ground truth data. The sampling unit 112 selects, for each ground truth region included in the ground truth data, a pixel having the highest certainty factor in the heat map from among pixels at least partially included in the ground truth region. Then, the sampling unit 112 samples the feature values at the pixel positions on the feature map corresponding to the selected pixels. In the first sampling, the sampling unit 112 extracts, for each of the n ground truth regions included in the ground truth data, a feature value corresponding to the pixel having the highest certainty factor, thereby sampling n feature values.

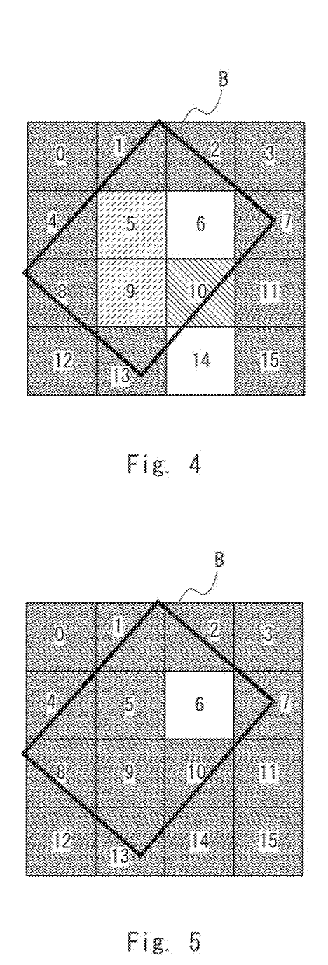

Specific examples of the processing of the first sampling by the sampling unit 112 will be described with reference to FIGS. 4 and 5. FIG. 4 is a diagram illustrating an example of a heat map according to the present disclosure. FIG. 5 is a diagram illustrating another example of a heat map according to the present disclosure. The heat maps illustrated in FIGS. 4 and 5 are each an example including 16 pixels of H = 4 and W = 4 in a bird's-eye-view plane. The certainty factor of each pixel is represented by color intensity. The darker the color of the pixel, the lower the certainty factor, and the brighter the color, the higher the certainty factor. Furthermore, for convenience of description, each pixel is provided with an index for identifying the position of each pixel on the bird's-eye-view plane. A ground truth bounding box B indicates a ground truth region of a certain detection target on the bird's-eye-view plane.

The sampling unit 112 selects the pixel with the index 6, which is the pixel having the highest certainty factor, from among the pixels at least partially included in the ground truth bounding box B. Then, the sampling unit 112 samples the feature value at the pixel position on the feature map corresponding to the position of the pixel with the index 6. The sampling unit 112 executes the above processing on all the ground truth bounding boxes B, that is, all the ground truth regions.

The first sampling enables sampling at least one feature value for every ground truth region, that is, every positive. Therefore, the learning system 1 can learn for all the detection targets from the initial stage of learning. This improves the detection accuracy of the model 12.

Since the resolution of the heat map is finite, each pixel has a certain physical size. Therefore, the center position of the detection target may extend over a plurality of pixels on the heat map. However, the heat map of the ground truth data used for training is configured such that a certainty factor is assigned to only one pixel corresponding to the center position of the detection target. In such a configuration, the information regarding the actual center position of the detection target is represented in an ambiguous manner on the heat map, and the training result ii also likely to be unclear. As a result, a high certainty factor may be given to a plurality of pixels near the center position for the same detection target. In this case, a clear peak is not formed at a position corresponding to the detection target in the heat map, and instead a blurred certainty factor distribution appears near the center of the detection target. Then, at the time of sampling, overlapping feature values corresponding to the same detection target may be selected. Such overlapping sampling for the same object results in a plurality of detection results being output for the same detection target, causing redundant detections.

However, in the present second example embodiment, in the first sampling, the sampling unit 112 does not simply sample the feature value corresponding to the center position of a ground truth region, but selects and samples the feature value corresponding to the position having the highest certainty factor in the heat map. As a result, as illustrated in FIG. 5, the model 12 can easily learn a clearer peak at the center position of the detection target so that overlapping sampling for the same detection target is suppressed. This improves the detection accuracy of the model 12.

Note that, in the first sampling, in a case where a plurality of ground truth bounding boxes B share the pixel having the highest certainty factor, a sampling conflict occurs over the pixel. To address this, the sampling unit 112 may perform processing for eliminating overlapping sampling of the pixel. For example, the sampling unit 112 randomly selects one of the ground truth bounding boxes B corresponding to the pixel. Then, the sampling unit 112 samples the feature value corresponding to the pixel for the selected ground truth bounding box B. On the other hand, with respect to the other ground truth bounding boxes B that were not selected, the sampling unit 112 excludes the pixel, re-selects another pixel having the highest certainty factor in the ground truth bounding box B, and samples the feature value corresponding to that pixel. By executing the processing for eliminating overlapping sampling in this manner, the learning system 1 can improve the stability of training and the detection accuracy.

Next, the second sampling will be described. The second sampling is processing of extracting feature values corresponding to a predetermined number of pixels having the highest certainty factors among the remaining pixels excluding the pixel sampled by the first sampling. After the first sampling, the sampling unit 112 selects a predetermined number (k - n) of pixels having the highest certainty factors from among the remaining pixels. Then, the second sampling samples the feature values at the pixel positions on the feature map corresponding to the selected pixels. The predetermined number may be appropriately set according to the number of ground truth regions.

The second sampling allows the sampling unit 112 to also sample feature values corresponding to pixels that are not included in the ground truth regions but are determined to have a high certainty factor. That is, in the second sampling, hard negatives are sampled. By the learning system 1 learning hard negatives, the model 12 can suppress erroneous detection and can further improve the discrimination performance between the detection target and the background. In particular, learning is also performed on background regions and unlabeled regions where the certainty factor is likely to be high, so that the ability to discriminate hard negatives that cause erroneous detection is enhanced, and the detection accuracy of the model 12 is improved.

In addition, by adopting a configuration in which a predetermined number (k - n) of feature values having the highest certainty factors among the remaining pixels after the first sampling are extracted by the second sampling, the learning system 1 can calculate a loss limited to the detection target and the background regions having high certainty factors instead of targeting the entire heat map. As a result, the learning system 1 can suppress the learning from being biased in a direction that the model 12 is specialized in the background due to the structural imbalance where the number of background pixels is overwhelmingly larger than that of the detection targets.

The sampling unit 112 outputs k feature values sampled by the first sampling and the second sampling to the detection unit 113.

The description returns to FIG. 3. The detection unit 113 acquires, from the sampling unit 112, n feature values sampled by the first sampling and (k - n) feature values sampled by the second sampling. The detection unit 113 detects k regions on the bird's-eye-view plane by applying predetermined neural network processing on the sampled k feature values. In addition, the detection unit 113 calculates a certainty factor for each of the detected regions. That is, the detection unit 113 detects k regions and calculates k certainty factors. Hereinafter, the regions detected by the detection unit 113 are referred to as prediction regions, and the certainty factors calculated by the detection unit 113 are referred to as prediction certainty factors.

The loss calculation unit 114 acquires n pieces of ground truth data from the training database 10. In addition, the loss calculation unit 114 acquires k prediction regions and k prediction certainty factors from the detection unit 113. Then, the loss calculation unit 114 calculates a regional loss based on the comparison between the prediction regions and the ground truth regions and a certainty factor loss based on the comparison between the prediction certainty factors and the ground truth certainty factors.

More specifically, first, the loss calculation unit 114 establishes a correspondence between the k prediction regions and the n ground truth regions using an allocation matrix. Then, the loss calculation unit 114 extracts n prediction regions corresponding to the n ground truth regions from the k prediction regions. The loss calculation unit 114 determines the extracted n prediction regions as prediction regions for the detection targets. The allocation matrix is configured based on a matching algorithm such as a Hungarian algorithm, for example, and the loss calculation unit 114 determines the optimum correspondence based on the similarity between each prediction region and each ground truth region.

Then, for the extracted n prediction regions for the detection targets, the loss calculation unit 114 calculates a regression error against the corresponding ground truth regions as a regional loss. The regional loss is a loss with respect to a difference in position between the prediction region for a detection target and the ground truth region, and for example, an L1 loss or an intersection over union (IoU) loss may be used. The loss calculation unit 114 may also calculate a loss in speed information of the detection target or the like.

The loss calculation unit 114 adds the ground truth certainty factors of negatives corresponding to background regions or the like that are not detection targets to the ground truth certainty factors included in the ground truth data. Specifically, the loss calculation unit 114 sets the ground truth certainty factors included in the ground truth data for the n prediction regions associated with the n ground truth regions among the k prediction regions. On the other hand, for the remaining (k - n) prediction regions that do not correspond to ground truth regions, the loss calculation unit 114 sets, for example, a new ground truth certainty factor of 0 to the negatives regarded as background regions. Then, the loss calculation unit 114 calculates a certainty factor loss of the newly set k ground truth certainty factors against the k prediction certainty factors. As a result, the learning proceeds so that a high certainty factor is output for the positives and a low certainty factor is output for the negatives. Note that the certainty factor loss is calculated using, for example, cross-entropy loss. In addition, the pixel index is the same for a prediction certainty factor and the corresponding ground truth certainty factor so that the loss calculation can be performed in a one-to-one correspondence.

After calculating the regional loss and the certainty factor loss as described above, the loss calculation unit 114 weights the regional loss and the certainty factor loss with certain weights and adds them together to obtain a total loss. Then, the loss calculation unit 114 outputs the total loss to the update unit 115.

The update unit 115 updates the parameters of the model 12 based on the total loss input from the loss calculation unit 114.

### Configuration of Detection System

The configuration of the learning system 1 has been described above. Next, the detection system 2 will be described. The detection system 2 is a system that executes object detection using the model 12 on which machine learning has been performed by the learning system 1. As illustrated in FIG. 2, the detection system 2 includes an acquisition unit 20, a detection unit 21, and an output unit 22.

The acquisition unit 20 acquires one or more pieces of sensor data such as image data or point cloud data acquired from a sensor, a camera, or the like as input data to the detection unit 21.

The detection unit 21 inputs the sensor data acquired by the acquisition unit 20 to the model 12, and detects regions of detection targets by the model 12.

The output unit 22 displays detection results by the detection unit 21, such as regions of detection targets, certainty factors, and class labels on a monitor (not illustrated) or outputs the detection results to an external system.

### Learning Method

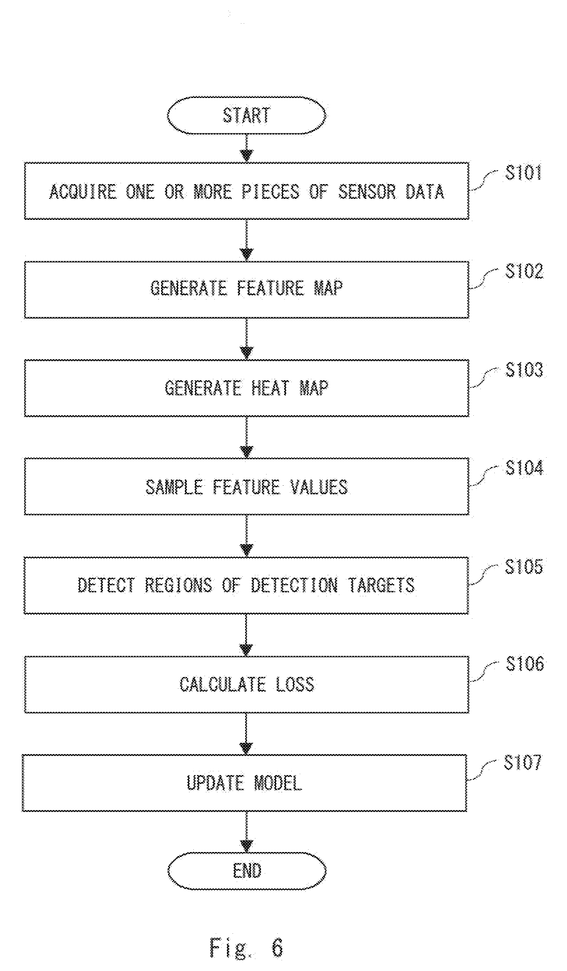

The configurations of the learning system 1 and the detection system 2 have been described above. Next, an example of a learning method by the learning system 1 will be described with reference to FIG. 6. FIG. 6 is a flowchart illustrating an example of a learning method according to the present disclosure.

First, the feature map generation unit 110 acquires one or more pieces of sensor data from the training database 10 (step S101).

Next, the feature map generation unit 110 generates a feature map indicating a feature value for each pixel on a bird's-eye-view plane based on the obtained one or more pieces of sensor data (step S102). The feature map is represented by, for example, a three-dimensional tensor of [D, H, W]. The symbol D indicates the number of dimensions of the feature vector corresponding to each pixel, and the feature vector includes, for example, image features, point cloud features, position information, and the like. The symbols H and W are the numbers of divisions in the height direction and the width direction of the bird's-eye-view plane.

Next, the heat map generation unit 111 generates a heat map indicating, for each pixel on the bird's-eye-view plane, the certainty factor of the presence of a plurality of detection targets based on the feature map generated in S102 (step S103). The heat map is represented by, for example, a three-dimensional tensor of [n, H, W], with a certainty factor held in each pixel.

Next, the sampling unit 112 samples k feature values based on the ground truth data of the training database 10, the feature map generated in step S102, and the heat map generated in step S103 (step S104).

Then, the detection unit 113 detects k regions on the bird's-eye-view plane for the k feature values sampled in step S104 (step S105). In addition, in step S105, the detection unit 113 calculates a certainty factor for each of the detected regions (prediction regions). The detection unit 113 outputs the prediction regions and the certainty factors (prediction certainty factors) for the prediction regions to the loss calculation unit 114.

Then, the loss calculation unit 114 calculates a regional loss based on the comparison between the prediction regions and the ground truth regions and a certainty factor loss based on the comparison between the prediction certainty factors and the ground truth certainty factors (step S106). The loss calculation unit 114 weights the regional loss and the certainty factor loss with certain weights and adds them together to obtain a total loss. Then, the loss calculation unit 114 outputs the total loss to the update unit 115.

Finally, the update unit 115 updates the parameters of the model 12 based on the total loss calculated in step S106 (step S107).

### Sampling Method

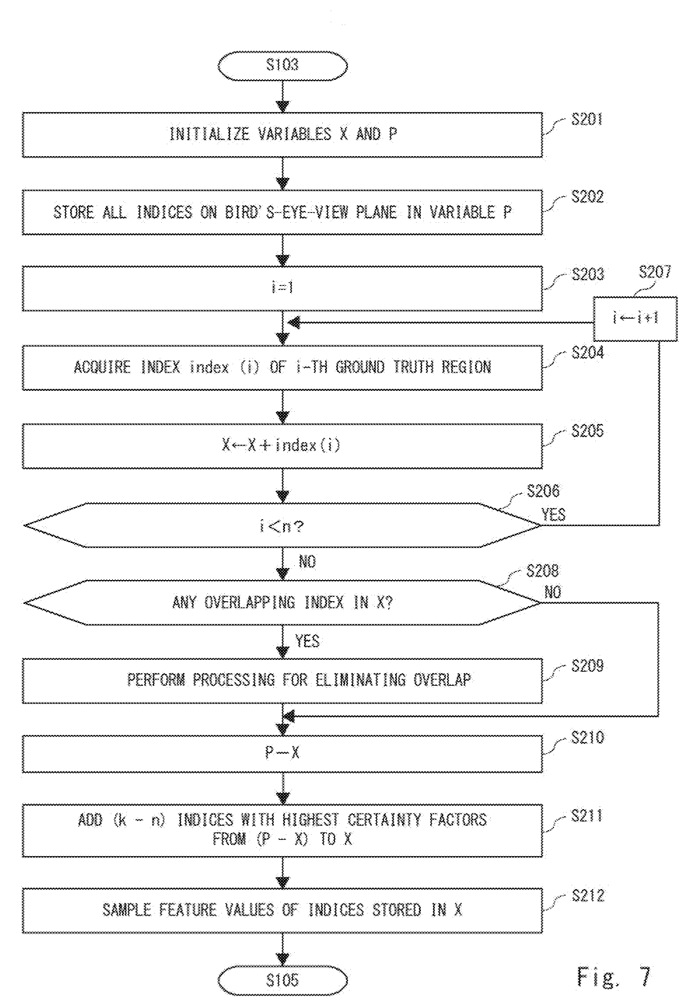

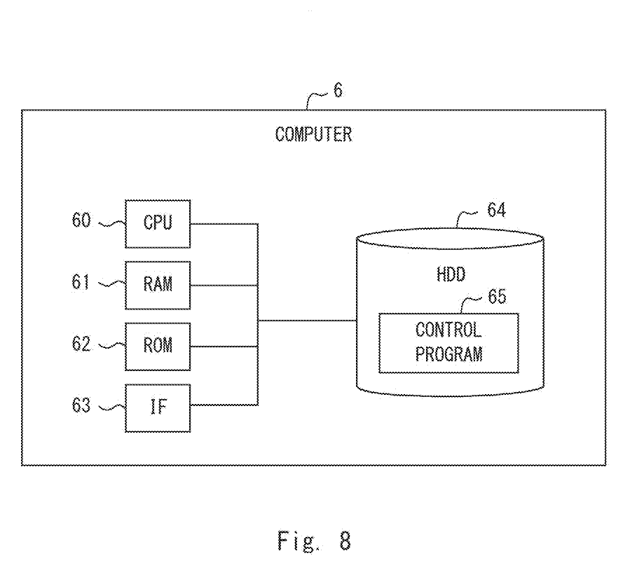

Next, the feature value sampling method in step S104 will be described in detail with reference to FIG. 7. FIG. 7 is a flowchart illustrating an example of a sampling method according to the present disclosure. The processing illustrated in FIG. 7 is an example of processing of sampling k feature values to be learned from the feature map on the bird's-eye-view plane during learning. The first sampling process mainly corresponds to steps S203 to 209, and the second sampling process mainly corresponds to steps S210 to 211.

First, the sampling unit 112 initializes a variable X for storing the indices of the sampling targets and a variable P for storing all indices on the bird's-eye-view plane (step S201).

The variable X is a variable for holding indices for identifying the positions of pixels on the bird's-eye-view plane. The variable X finally holds k indices in the flow illustrated in FIG. 7. In this step S201, the variable X is initialized and defined as an empty set in the initial state.

The variable P is a variable for storing a set in which all indices on the bird's-eye-view plane are listed. For example, in a case where the bird's-eye-view plane is divided into H pixels in the height direction and W pixels in the width direction, the variable P has a structure that stores indices of positions of all the H × W pixels. The variable P configured in this manner is used to select hard negatives, such as background regions that are likely to be erroneously detected, after removing indices corresponding to the ground truth regions in subsequent processing. In this step S201, the variable P is initialized and defined as an empty set in the initial state.

Next, the sampling unit 112 stores indices of all pixel positions on the bird's-eye-view plane in the variable P (step S202). More specifically, in a case where the bird's-eye-view plane is divided into pixels of H in the height direction and W in the width direction at a predetermined resolution, the indices of the positions of all the H × W pixels are listed and stored in the variable P.

Next, the sampling unit 112 initializes a counter i, where i is an integer of 1 or more (step S203). In this step S201, the counter i is initialized and defined as 1 in the initial state. Note that the counter i is used for the processing of extracting feature values corresponding to pixels having the highest certainty factors among pixels in the ground truth regions of the ground truth data, that is, for the first sampling.

Next, the sampling unit 112 acquires an index index(i) corresponding to the i-th ground truth region (step S204). The sampling unit 112 selects the pixel having the highest certainty factor in the heat map from among pixels at least partially included in the i-th ground truth region. Then, the sampling unit 112 acquires the index of the pixel as an index index(i).

Note that, in step S204, in a case where there are a plurality of pixels having the highest certainty factor among the pixels at least partially included in the i-th ground truth region, or in a case where there is no pixel having a certainty factor equal to or higher than a predetermined threshold value in the ground truth region due to noise, an estimation error, or the like, the sampling unit 112 selects the pixel at the position closest to the center position based on the distance between the center position of the ground truth region and the position of each pixel on the bird's-eye-view plane. Then, the sampling unit 112 acquires the index of the pixel as an index index(i).

Next, the sampling unit 112 adds the index index(i) acquired in step S204 to the variable X (Step S205).

Next, the sampling unit 112 determines whether the counter i has reached n (step S206). Note that n is the number of ground truth regions included in the ground truth data. In a case where the counter i is less than n (step S206: YES), the sampling unit 112 adds 1 to the counter i (step S207). Then, the sampling unit 112 executes step S204 again.

On the other hand, in a case where the counter i has reached n (step S206: NO), that is, in a case where the process of acquiring the index index(i) for all the ground truth regions and adding the indices to the variable X has been completed, the sampling unit 112 proceeds to the next processing step S208. As a result, the indices corresponding to all the ground truth regions included in the ground truth data are stored in the variable X, and the index information corresponding to all the detection targets is aggregated into the variable X.

In a case where the counter i has reached n (step S206: NO), the sampling unit 112 determines whether an overlapping index exists in the variable X (step S208). That is, the sampling unit 112 confirms whether the same index is not allocated to a plurality of ground truth regions.

In a case where there is an overlapping index in the variable X (step S208: YES), the sampling unit 112 executes processing of eliminating the overlap (step S209).

For example, the sampling unit 112 randomly selects one of the ground truth regions corresponding to the overlapping index. Then, the sampling unit 112 holds the overlapping index in the variable X for the selected ground truth region. On the other hand, for the other ground truth regions that were not selected, the sampling unit 112 excludes the overlapping index and then re-selects a pixel having the next highest certainty factor in each ground truth region. Then, the sampling unit 112 stores the indices of those pixels in the variable X as the indices of the other ground truth regions that were not selected.

As another method, the sampling unit 112 calculates the degree of match between each ground truth region and a prediction region detected based on the feature value corresponding to the overlapping index. Then, for the ground truth region with the highest degree of match, the sampling unit 112 holds the overlapping index in the variable X. On the other hand, for the other ground truth regions, the sampling unit 112 excludes the overlapping index and then re-selects a pixel having the next highest certainty factor in each ground truth region. Then, the sampling unit 112 stores the indices of those pixels in the variable X as the indices of the other ground truth regions that were not selected.

After the index overlap in the variable X is resolved in step S209, or in a case where there is no overlapping index in the variable X after step S208 (step S208: NO), the sampling unit 112 proceeds to the next processing step S210.

The above processing in steps S203 to 209 mainly corresponds to the index selection processing in the first sampling. Through these processes, the sampling unit 112 can reliably allocate one positive index to every ground truth region (n) in the ground truth data. As a result, the learning system 1 can acquire the feature values for all the detection targets and perform exhaustive learning from the initial stage of learning. After the indices sampled for all the ground truth regions are determined, the sampling unit 112 proceeds to the next processing of selecting negative candidates, that is, the second sampling, based on the indices stored in the variable X.

Next, sampling unit 112 removes the variable X from the variable P (Step S210). Here, the variable P is a set that stores indices of all pixel positions on the bird's-eye-view plane, and the variable X includes positive indices already selected by the first sampling. That is, (P - X) obtained by removing the variable X from the variable P in step S210 holds the remaining unused indices.

Next, the sampling unit 112 selects (k - n) indices having the highest certainty factors from (P - X) obtained in step S210 based on the certainty factors in the heat map, and adds these indices to the variable X (step S211). As described above, k is the total number of indices to be finally stored in the variable X, and n is the number of ground truth regions. Therefore, (k - n) is the number of indices corresponding to the negatives. In step S210, background regions that have high certainty factors and are likely to be erroneously detected, that is, hard negatives, are sampled as learning targets. This allows the model 12 to have improved discrimination performance between the detection targets and the background. In addition, the overfitting bias at the initial stage of learning is suppressed.

The above processing in steps S210 to 211 mainly corresponds to the index selection processing in the second sampling. Through these processes, the sampling unit 112 can appropriately select the hard negative indices that are likely to be erroneously detected and add them to the variable X. As a result, the variable X includes the positive indices corresponding to the ground truth regions and the negative indices corresponding to the background regions in a well-balanced manner.

Finally, based on the indices stored in the variable X, the sampling unit 112 samples the corresponding feature values from the feature map (step S212). In this step, the sampling unit 112 samples k feature values corresponding to n positive indices and (k - n) negative indices, that is, a total of k indices, from the corresponding positions on the feature map. Then, the sampling unit 112 outputs the sampled k feature values to the detection unit 113.

As described above, the learning system 1 trains the model 12 by using the ground truth data including a ground truth region for each of the detection targets on the bird's-eye-view plane and ground truth certainty factors for the ground truth regions, and the input data of one or more pieces of sensor data. In the training of the model 12, the learning system 1 first generates a feature map of a bird's eye view based on the input data. In addition, the learning system 1 generates a heat map indicating, for each pixel on the bird's-eye-view plane, the presence certainty factor for a detection target based on the feature map. Then, the learning system 1 samples feature values based on the ground truth data, the feature map, and the heat map. The sampled feature values are used as inputs to prediction processing executed for loss calculation.

In the sampling of feature values, first, the learning system 1 identifies, for each ground truth region included in the ground truth data, the pixel having the highest certainty factor on the heat map among pixels at least partially included in the ground truth region, and samples the feature value corresponding to the pixel (first sampling). By the first sampling, the learning system 1 can sample at least one feature value for every ground truth region, that is, every positive. Therefore, the learning system 1 can learn for all the detection targets from the initial stage of learning. This improves the detection accuracy of the model 12. Furthermore, in the first sampling, the learning system 1 does not simply sample the feature value corresponding to the center position of a ground truth region, but selects and samples the feature value corresponding to the position having the highest certainty factor in the heat map. As a result, as illustrated in FIG. 5, the learning system 1 can easily learn a clearer peak at the center position of the detection target, and the detection accuracy of the model 12 is improved.

The learning system 1 further samples feature values corresponding to a predetermined number of pixels having the highest certainty factors among the remaining pixels excluding the pixel sampled by the first sampling (second sampling). The second sampling allows the learning system 1 to also learn feature values corresponding to pixels that are not included in the ground truth regions but are determined to have a high certainty factor. As a result, the model 12 can suppress erroneous detection, and can also improve discrimination performance between the detection targets and the background. In addition, by adopting a configuration in which a predetermined number of feature values having the highest certainty factors among the remaining pixels after the first sampling are extracted by the second sampling, the learning system 1 can calculate a loss limited to the detection target and the background regions having high certainty factors instead of targeting the entire heat map. As a result, the learning system 1 can suppress the learning from being biased in a direction that the model 12 is specialized in the background due to the structural imbalance where the number of background pixels is overwhelmingly larger than that of the detection targets.

### Configuration of Hardware for Implementing Processing Function of Learning System

Some or all of the processing achieved by the learning system 1 can be achieved by a general-purpose computer system. This will be briefly described below with reference to FIG. 8.

FIG. 8 is a block diagram illustrating an example of a hardware configuration that implements the processing of the learning system according to the present disclosure. A computer 6 includes, for example, a Central Processing Unit (CPU) 60 which is a control device, a Random Access Memory (RAM) 61, and a Read Only Memory (ROM) 62. The computer 6 further includes an Interface (IF) 63 that is an interface with the outside and a Hard Disk Drive (HDD) 64 that is an example of a nonvolatile storage device. Furthermore, the computer 6 may include an input device such as a keyboard and a mouse and a display device such as a display as other configurations (not illustrated).

The HDD 64 stores an Operating System (OS) (not illustrated) and a control program 65. The control program 65 is a computer program (learning program) in which the processing of the learning system 1 is implemented.

The CPU 60 controls various processing in the computer 6, accesses to the RAM 61, the ROM 62, the IF 63, and the HDD 64, and the like. In the computer 6, the CPU 60 reads and executes the OS and the control program 65 stored in the HDD 64. As a result, the computer 6 achieves the processing of the learning system 1.

The above-described program includes a command group (or software codes) for causing a computer to perform one or more functions that have been described in the present disclosure in a case where the program is read by the computer. The program may be stored in a non-transitory computer-readable medium or a tangible storage medium. As an example and not by way of limitation, the computer-readable medium or the tangible storage medium includes a RAM, a ROM, a flash memory, a Solid-State Drive (SSD) or any other memory technique, a CD-ROM, a Digital Versatile Disc (DVD), a Blu-ray (registered trademark) disc or any other optical disc storage, a magnetic cassette, a magnetic tape, a magnetic disk storage, or any other magnetic storage device. The program may be transmitted on a transitory computer-readable medium or a communications medium. As an example and not by way of limitation, transitory computer-readable or communication media include electrical, optical, acoustic, or other forms of propagated signals.

As with the above learning system 1, some or all of the processing achieved by the detection system 2 can be achieved by a general-purpose computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure. And each example embodiment can be appropriately combined with other example embodiments.

Each of the drawings is merely an example to illustrate one or a plurality of example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing exemplary example embodiments are not necessarily mandatory, and some features or steps may be omitted. The order of the steps described in any of the drawings may be changed as appropriate.

Some or all of the above example embodiments may be described as the following Supplementary Notes, but are not limited to the following.

### Supplementary Note 1

A learning system including:
a feature map generation unit that generates a feature map indicating a feature value for each pixel on a bird's-eye-view plane based on one or more pieces of sensor data;
a heat map generation unit that generates a heat map indicating a certainty factor of the presence of a plurality of detection targets for each pixel on the bird's-eye-view plane based on the feature map;
a sampling unit that executes, based on ground truth data including a ground truth region for each of the detection targets on the bird's-eye-view plane, the feature map, and the heat map, first sampling to sample, for each of the ground truth regions, the feature value corresponding to a pixel having the highest certainty factor among pixels at least partially included in the ground truth region;
a detection unit that detects regions of the detection targets on the bird's-eye-view plane based on the feature values sampled by the sampling unit;
a loss calculation unit that calculates a loss between the detected regions and the ground truth regions; and
an update unit that updates a model based on the loss.

### Supplementary Note 2

The learning system according to Supplementary Note 1, wherein
the sampling unit executes second sampling to sample the feature values respectively corresponding to a predetermined number of pixels having the highest certainty factors in the heat map among the remaining pixels excluding the pixel sampled by the first sampling.

### Supplementary Note 3

The learning system according to Supplementary Note 1 or 2, wherein,
in the first sampling, the sampling unit,
in a case where two or more of the ground truth regions share the pixel having the highest certainty factor, randomly selects one of the two or more ground truth regions,
samples the feature value corresponding to the shared pixel for the selected ground truth region, and,
for the one or more ground truth regions that were not selected, samples the feature value corresponding to the pixel having the highest certainty factor among the pixels excluding the shared pixel.

### Supplementary Note 4

The learning system according to any one of Supplementary Notes 1 to 3, wherein,
in the first sampling, the sampling unit,
in a case where two or more of the ground truth regions share the pixel having the highest certainty factor, selects one of the two or more ground truth regions based on a correspondence between a region of the detection target detected based on the feature value corresponding to the shared pixel and each of the ground truth regions,
samples the feature value corresponding to the shared pixel for the selected ground truth region, and,
for the one or more ground truth regions that were not selected, samples the feature value corresponding to the pixel having the highest certainty factor among the pixels excluding the shared pixel.

### Supplementary Note 5

The learning system according to any one of Supplementary Notes 1 to 4, wherein
the ground truth data includes the ground truth regions and ground truth certainty factors for the ground truth regions,
the detection unit detects the regions of the detection targets on the bird's-eye-view plane based on the feature values sampled by the sampling unit and calculates the certainty factors for the regions, and
the loss calculation unit calculates a loss between the detected regions and the ground truth regions and a loss between the calculated certainty factors and the ground truth certainty factors.

### Supplementary Note 6

The learning system according to any one of Supplementary Notes 1 to 5, wherein,
in the first sampling, the sampling unit,
in a case where there are a plurality of pixels having the highest certainty factor among the pixels at least partially included in the ground truth region, or in a case where there is no pixel having a certainty factor equal to or greater than a predetermined threshold value in the ground truth region, selects a pixel at a position closest to the center position of the ground truth region, and samples the feature value corresponding to the selected pixel.

### Supplementary Note 7

The learning system according to any one of Supplementary Notes 1 to 6, wherein
the regions and the ground truth regions are bounding boxes.

### Supplementary Note 8

A detection system including:
an acquisition unit that acquires one or more pieces of sensor data; and
a detection unit that receives the sensor data as an input and detects one or more regions of detection targets by using a model trained through machine learning to detect the regions on a bird's-eye-view plane,
wherein the model is a model trained by the learning system according to any one of Supplementary Notes 1 to 7.

### Supplementary Note 9

A learning method including:
a feature map generation step of generating a feature map indicating a feature value for each pixel on a bird's-eye-view plane based on one or more pieces of sensor data;
a heat map generation step of generating a heat map indicating a certainty factor of the presence of a plurality of detection targets for each pixel on the bird's-eye-view plane based on the feature map;
a sampling step of sampling, based on ground truth data including a ground truth region for each of the detection targets on the bird's-eye-view plane, the feature map, and the heat map, for each of the ground truth regions, the feature value corresponding to a pixel having the highest certainty factor among pixels at least partially included in the ground truth region;
a detection step of detecting regions of the detection targets on the bird's-eye-view plane based on the sampled feature values;
a loss calculation step of calculating a loss between the detected regions and the ground truth regions; and
an update step of updating a model based on the loss.

### Supplementary Note 10

A learning program that causes a computer to execute:
feature map generation processing of generating a feature map indicating a feature value for each pixel on a bird's-eye-view plane based on one or more pieces of sensor data;
heat map generation processing of generating a heat map indicating a certainty factor of the presence of a plurality of detection targets for each pixel on the bird's-eye-view plane based on the feature map;
sampling processing of sampling, based on ground truth data including a ground truth region for each of the detection targets on the bird's-eye-view plane, the feature map, and the heat map, for each of the ground truth regions, the feature value corresponding to a pixel having the highest certainty factor among pixels at least partially included in the ground truth region;
detection processing of detecting regions of the detection targets on the bird's-eye-view plane based on the sampled feature values;
loss calculation processing of calculating a loss between the detected regions and the ground truth regions; and
update processing of updating a model based on the loss.

Some or all of the elements (such as configurations and functions, for example) described in Supplementary Notes 2 to 8 depending on Supplementary Note 1 may depend from Supplementary Notes 9 to 10 as well with depending relationships similar to those of Supplementary Notes 2 to 8. Some or all of the elements described in any Supplementary Note may be applied to various types of hardware, software, recording means for recording software, systems, and methods.

1. A learning system comprising:
at least one memory storing instructions; and
at least one processor configured to execute the instructions to;
generate a feature map indicating a feature value for each pixel on a bird's-eye-view plane based on one or more pieces of sensor data;
generate a heat map indicating a certainty factor of the presence of a plurality of detection targets for each pixel on the bird's-eye-view plane based on the feature map;
execute, based on ground truth data including a ground truth region for each of the detection targets on the bird's-eye-view plane, the feature map, and the heat map, first sampling to sample, for each of the ground truth regions, the feature value corresponding to a pixel having the highest certainty factor among pixels at least partially included in the ground truth region;
detect regions of the detection targets on the bird's-eye-view plane based on the feature values sampled by the sampling;
calculate a loss between the detected regions and the ground truth regions; and
update a model based on the loss.

2. The learning system according to claim 1, wherein the at least one processor is further configured to execute the instructions to:
execute second sampling to sample the feature values respectively corresponding to a predetermined number of pixels having the highest certainty factors in the heat map among the remaining pixels excluding the pixel sampled by the first sampling,
detect regions of the detection targets on the bird's-eye-view plane based on the feature values sampled by the first sampling and second sampling.

3. The learning system according to claim 1, wherein the at least one processor is further configured to execute the instructions to:
in the first sampling,
in a case where two or more of the ground truth regions share the pixel having the highest certainty factor, randomly select one of the two or more ground truth regions,
sample the feature value corresponding to the shared pixel for the selected ground truth region, and,
for the one or more ground truth regions that were not selected, sample the feature value corresponding to the pixel having the highest certainty factor among the pixels excluding the shared pixel.

4. The learning system according to claim 1, wherein the at least one processor is further configured to execute the instructions to:
in the first sampling,
in a case where two or more of the ground truth regions share the pixel having the highest certainty factor, select one of the two or more ground truth regions based on a correspondence between a region of the detection target detected based on the feature value corresponding to the shared pixel and each of the ground truth regions,
sample the feature value corresponding to the shared pixel for the selected ground truth region, and,
for the one or more ground truth regions that were not selected, sample the feature value corresponding to the pixel having the highest certainty factor among the pixels excluding the shared pixel.

5. The learning system according to claim 1, wherein
the ground truth data includes the ground truth regions and ground truth certainty factors for the ground truth regions,
the at least one processor is further configured to execute the instructions to:
detect the regions of the detection targets on the bird's-eye-view plane based on the feature values sampled by the sampling,
calculate the certainty factors for the regions, and
calculate a loss between the detected regions and the ground truth regions and a loss between the calculated certainty factors and the ground truth certainty factors.

6. The learning system according to claim 1, wherein the at least one processor is further configured to execute the instructions to:
in the first sampling,
in a case where there are a plurality of pixels having the highest certainty factor among the pixels at least partially included in the ground truth region, or in a case where there is no pixel having a certainty factor equal to or greater than a predetermined threshold value in the ground truth region, select a pixel at a position closest to the center position of the ground truth region, and
sample the feature value corresponding to the selected pixel.

7. The learning system according to claim 1, wherein
the regions and the ground truth regions are bounding boxes.

8. The learning system according to claim 1, wherein
the model receives one or more pieces of sensor data as an input and detects one or more regions of detection targets on a bird's-eye-view plane.

9. A learning method executed by at least one processor, the learning method comprising:
a feature map generation step of generating a feature map indicating a feature value for each pixel on a bird's-eye-view plane based on one or more pieces of sensor data;
a heat map generation step of generating a heat map indicating a certainty factor of the presence of a plurality of detection targets for each pixel on the bird's-eye-view plane based on the feature map;
a sampling step of sampling, based on ground truth data including a ground truth region for each of the detection targets on the bird's-eye-view plane, the feature map, and the heat map, for each of the ground truth regions, the feature value corresponding to a pixel having the highest certainty factor among pixels at least partially included in the ground truth region;
a detection step of detecting regions of the detection targets on the bird's-eye-view plane based on the sampled feature values;
a loss calculation step of calculating a loss between the detected regions and the ground truth regions; and
an update step of updating a model based on the loss.

10. A non-transitory computer-readable medium storing a learning program for causing a computer to perform:
feature map generation processing of generating a feature map indicating a feature value for each pixel on a bird's-eye-view plane based on one or more pieces of sensor data;
heat map generation processing of generating a heat map indicating a certainty factor of the presence of a plurality of detection targets for each pixel on the bird's-eye-view plane based on the feature map;
sampling processing of sampling, based on ground truth data including a ground truth region for each of the detection targets on the bird's-eye-view plane, the feature map, and the heat map, for each of the ground truth regions, the feature value corresponding to a pixel having the highest certainty factor among pixels at least partially included in the ground truth region;
detection processing of detecting regions of the detection targets on the bird's-eye-view plane based on the sampled feature values;
loss calculation processing of calculating a loss between the detected regions and the ground truth regions; and
update processing of updating a model based on the loss.
